(19) United States
(12) Patent Application Publication
(10) Pub. No.: US 2017/0178107 A1
(43) Pub. Date: Jun. 22, 2017

(54) INFORMATION PROCESSING APPARATUS, INFORMATION PROCESSING METHOD, RECORDING MEDIUM AND POS TERMINAL APPARATUS

(71) Applicant: NEC Corporation, Tokyo (JP)

(72) Inventors: Kota IWAMOTO, Tokyo (JP); Tetsuo INOSHITA, Tokyo (JP); Soma SHIRAISHI, Tokyo (JP); Hiroshi YAMADA, Tokyo (JP); Jun KOBAYASHI, Tokyo (JP); Eiji MURAMATSU, Tokyo (JP); Hideo YOKOI, Tokyo (JP); Tsugunori TAKATA, Tokyo (JP)

(21) Appl. No.: 15/129,363

(22) PCT Filed: Feb. 26, 2015
(86) PCT No.: PCT/JP2015/000995

§ 371 Date: Sep. 26, 2016

(30) Foreign Application Priority Data
Mar. 27, 2014 (JP) 2014-065932

(51) Int. Cl. G06Q 20/20

(52) U.S. Cl. CPC G06Q 20/208

(57) ABSTRACT

An information processing apparatus includes: a determining unit that determines whether at least a part of an object is present in an image captured or not; and a control unit that performs a control so as to display, on a display apparatus, a guiding sign for guiding the object in the image to a predetermined direction in a case that at least a part of the object is present in the image.

### TECHNICAL FIELD

The present invention relates to an apparatus using a technology for identifying an object. The present invention relates to a POS (Point Of Sales) terminal apparatus using a technology for identifying an object.

### BACKGROUND ART

Patent Literature 1 discloses a barcode scanner technology. An image determining unit of a barcode scanner determines whether or not an image which is a candidate for a barcode is present in an imaging frame for capturing the barcode. Next, a captured image display unit displays, on a display device, a guide image for guiding a barcode candidate image in order to enable the barcode candidate image is captured as the barcode, if a decode processing unit detects a partial lack of the barcode candidate image.

### CITATION LIST

### Patent Literature

PTL 1: Japanese Patent Application Laid-Open No. 2010-231436

### SUMMARY OF INVENTION

### Technical Problem

A problem exists, in which if the partial lack of the barcode candidate image cannot be detected, the guide image for guiding cannot be displayed and an object cannot be quickly identified.

An object of the invention is to provide a technology in which an object can be quickly identified in order to solve the above problem.

### Solution to Problem

A POS terminal apparatus according to one aspect of the present invention includes imaging means for imaging an object and generating an image thereof; display means for displaying a guiding sign for guiding the object in the image to a predetermined direction; determining means for determining whether at least a part of the object is present in the image or not; and control means for performing a control so as to display the guiding sign on the display means in a cases that at least a part of the object is present in the image.

An information processing apparatus according to one aspect of the present invention includes determining means for determining whether at least a part of an object is present in an image captured or not; and control means for performing a control so as to display, on a display apparatus, a guiding sign for guiding the object in the image to a predetermined direction in a case that at least a part of the object is present in the image.

An image processing method according to one aspect of the present invention includes determining whether at least a part of an object is present in an image captured or not; and displaying a guiding sign on a display apparatus for guiding the object in the image to the predetermined direction in a case where at least a part of the object is present in the image.

A computer-readable recording medium according to one aspect of the present invention, the recording medium storing a program that causes a computer to execute: determining whether at least a part of an object is present in an image captured or not; and displaying a guiding sign on a display apparatus for guiding the object in the image to the predetermined direction in a case where at least a part of the object is present in the image.

### Advantageous Effects of Invention

According to the invention, it is possible to quickly identify an object.

### BRIEF DESCRIPTION OF DRAWINGS

FIG. 1 is a diagram illustrating a summary of a POS terminal apparatus of a first exemplary embodiment of the invention,

FIG. 2 is a side view illustrating an appearance of the POS terminal apparatus of the first exemplary embodiment,

FIG. 3 is a block diagram illustrating a structure of the POS terminal apparatus of the first exemplary embodiment,

FIG. 4 is a flowchart illustrating operations of the POS terminal apparatus and an information processing apparatus of the first exemplary embodiment,

FIG. 5A is a diagram illustrating a positional relationship between an object and an imaging area in the first exemplary embodiment,

FIG. 5B is a diagram illustrating a guiding sign displayed in a display unit,

FIG. 5C is a diagram illustrating the guiding sign displayed on the display unit,

FIG. 6A is a diagram illustrating a positional relationship between the object and the imaging area in the first exemplary embodiment,

FIG. 6B is a diagram illustrating a guiding sign displayed on the display unit,

FIG. 7 is a block diagram illustrating a structure of a POS terminal apparatus in a second exemplary embodiment,

FIG. 8 is a flowchart illustrating operations of the POS terminal apparatus and an information processing apparatus of the second exemplary embodiment,

FIG. 9 is a diagram illustrating a hardware structure of a computer.

### DESCRIPTION OF EMBODIMENTS

### First Exemplary Embodiment

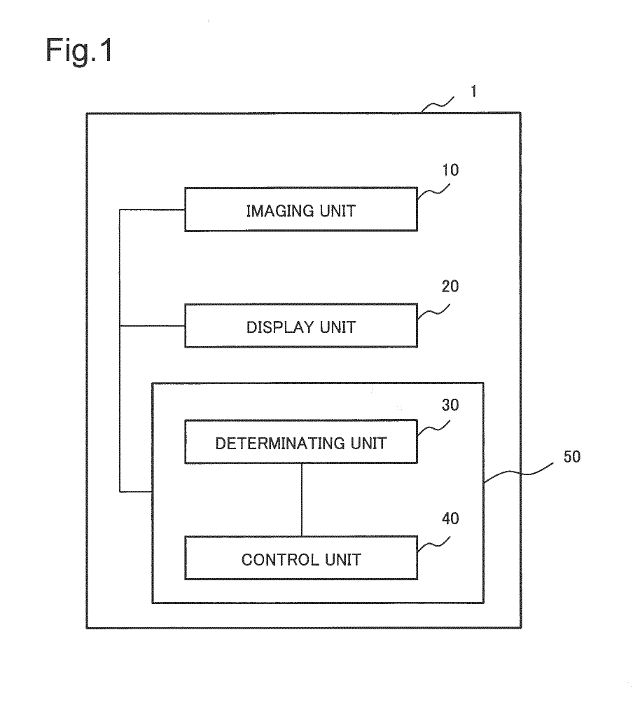

A summary of a first exemplary embodiment of the invention is explained. FIG. 1 is a diagram illustrating a summary of a POS terminal apparatus 1 of the first exemplary embodiment of the invention. As illustrated in FIG. 1, the POS terminal apparatus 1 includes an imaging unit 10, a display unit 20 and an information processing apparatus 50. The information processing apparatus 50 includes a determining unit 30 and a control unit 40.

The imaging unit 10 images an object to generate an image thereof. The display unit 20 displays the image captured by the imaging unit 10. The determining unit 30 of the information processing apparatus 50 determines whether or not at least a part of the object is present in the image captured by the imaging unit 10. The control unit 40 of the information processing apparatus 50 displays the guiding sign for guiding the object in the image to a predetermined direction on the display unit 20 in a case that a part of the object is present in the image captured by the imaging unit 10. For example, the guiding sign of the control unit 40 may be a guiding sign which performs guidance so that whole image of the object is displayed on a display screen of the display unit 20, or may be a guiding sign which guides the object in the direction in which the image of the object is brought into focus. The control unit 40 may performs a control so as to display the image of the object which the imaging unit 10 captures on the display unit 20, while displaying the guiding sign on the display unit 20.

When at least a part of the object is present in the image, the POS terminal apparatus 1 of the exemplary embodiment of the invention displays the guiding sign for guiding the object in the image in the predetermined direction, on the display unit 20. Thereby it is possible to quickly identify the object.

Described above is one example of the structure in which the POS terminal apparatus 1 includes the imaging unit 10, the display unit 20 and the information processing apparatus 50. It is not limited to the above structure. For example, a structure is available, in which the POS terminal apparatus 1 includes the imaging unit 10 and the display unit 20, the information processing apparatus 50 which is placed outside the POS terminal apparatus 1 includes the determining unit 30 and the control unit 40, and the POS terminal apparatus 1 is connected to the information processing apparatus 50 by wire or wireless

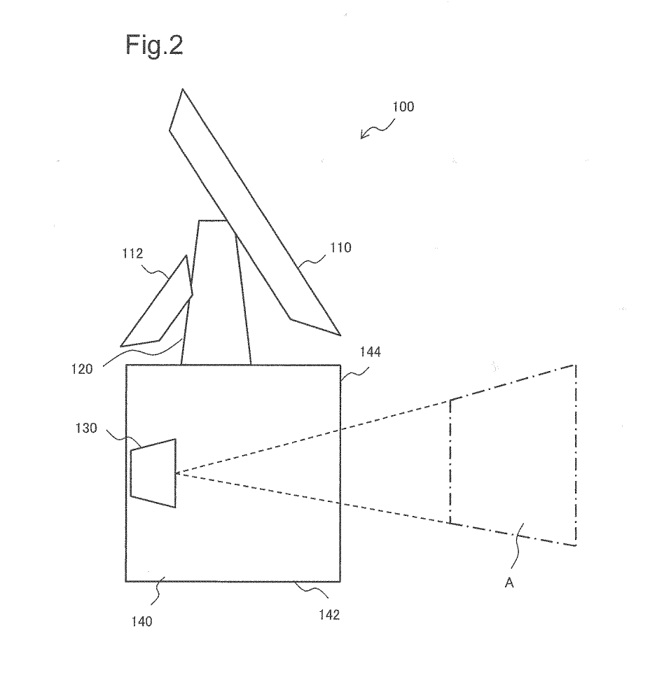

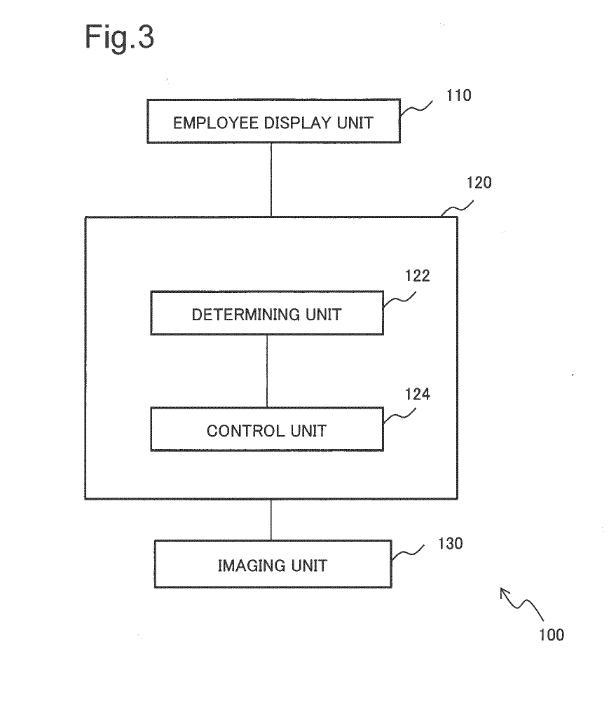

A specific example of the first exemplary embodiment is explained in detail using drawings. FIG. 2 is a side view illustrating an appearance of a POS terminal apparatus 100 which is a specific example of the first exemplary embodiment. FIG. 3 is a block diagram illustrating a structure of the POS terminal apparatus 100 of the first exemplary embodiment. The POS terminal apparatus 100 includes an employee display unit 110, a customer display unit 112, an information processing apparatus 120, and a merchandise reading apparatus 140. The employee display unit 110 illustrated in FIG. 2 displays information for employee, and the customer display unit 112 displays information for customer.

The employee display unit 110 and the customer display unit 112 may employ a touch panel display or LCD (Liquid Crystal Display). The employee display unit 110 and the customer display unit 112 may include an inputting apparatus such as a keyboard or the like. The employee display unit 110 displays information necessary for an employee under control of the information processing apparatus 120, and receives operations of an employee

The customer display unit 112 displays information necessary for a customer under control of the information processing apparatus 120, and may receive operations of a customer, if necessary.

The information processing apparatus 120 controls actions of the employee display unit 110, the customer display unit 112 and the merchandise reading apparatus 140. The information processing apparatus 120 performs necessary processing in response to operations received by the employee display unit 110. The information processing apparatus 120 performs necessary processing such as image processing in response to image information read by the merchandise reading apparatus 140.

The merchandise reading apparatus 140 includes a housing 142 and an imaging unit 130. A merchandise reading surface 144 having light transparency is arranged at a part of the housing 142. The merchandise reading surface 144 is arranged on a surface of an employee side of the housing 142 for work of employees, and an object is turned toward the surface 144 when the object is imaged. The imaging unit 130 is placed inside the housing 142. When an employee sets an object which is received from a customer toward the merchandise reading surface 144, the imaging unit 130 reads the image of the object. Thereby the POS terminal apparatus 100 performs identification processing for the object.

A range in which the imaging unit 130 captures an object (hereinafter, referred to as “imaging area”) depends on optical characteristics which are, for example, an angle of view, a focus of the lens, etc. of the imaging unit 130, and the like. An imaging area A is composed of a view-angle range which projects on the imaging unit 130 through the lens based on an angle of view and a focus range in which a clear image by focusing is obtained. The imaging area of the POS terminal apparatus 100 in FIG. 2 is illustrated as the imaging area A which is encircled by an alternate long and short dash line. In FIG. 2, the vertical direction of the view-angle range is illustrated by a chain line which extends from the imaging unit 130 through the merchandise reading surface 144. The horizontal direction of the view-angle range is not illustrated in FIG. 2. The starting point of the vertical direction and the horizontal direction is the position of the imaging unit 130. The focus range is a range of the depth direction from the imaging unit 130 to the merchandise reading surface 144. The horizontal direction of the view-angle range which is not illustrated in FIG. 2 is the vertical direction with respect to the vertical direction and the depth direction.

Detailed descriptions on the imaging unit 130 are as follows. The imaging unit 130 may take at least three forms described below. In a first case, the imaging unit 130 includes a two dimensional imaging unit for capturing a two dimensional image, a distance sensor for measuring a distance to a merchandise, and a distance image generation unit. The two dimensional imaging unit captures an image of an object facing the merchandise reading surface 144 and generates two dimensional color image or two dimensional monochrome image each including the image of the object.

The distance sensor measures a distance from the distance sensor to the position of the object facing the merchandise reading surface 144 based on TOF (Time Of Flight) system. The distance sensor emits a light beam, like an infrared beam, and measures the distance based on time it takes for the emitted light beam to go to the object and return. The distance image generation unit measures a distance at each position on the object, and superimpose the two dimensional images to generate a distance image (three dimensional image). In the first case, the imaging unit 130 can capture an image of an object in which distance to merchandise is within the predetermined range (e.g. 15 cm to 30 cm).

In a second case, the imaging unit 130 includes one dimensional imaging unit for capturing a two dimensional image. In the second case, an image of an object can be obtained by taking the difference between a background image which the imaging unit 130 captures in advance and an image including an object.

In a third case, the imaging unit 130 includes a plurality of two dimensional imaging units for capturing a two dimensional image and a distance image generation unit. The distance image generation unit can generates a distance image (three dimensional image) based on difference of an angle of view between the plurality of two dimensional imaging units.

A determining unit 122 determines whether or not at least a part of an object is present in an image. The processing may be realized, for example, when a program is executed under control of the control unit 124. Specifically the program stored in a memory unit (not illustrated) is executed and realized.

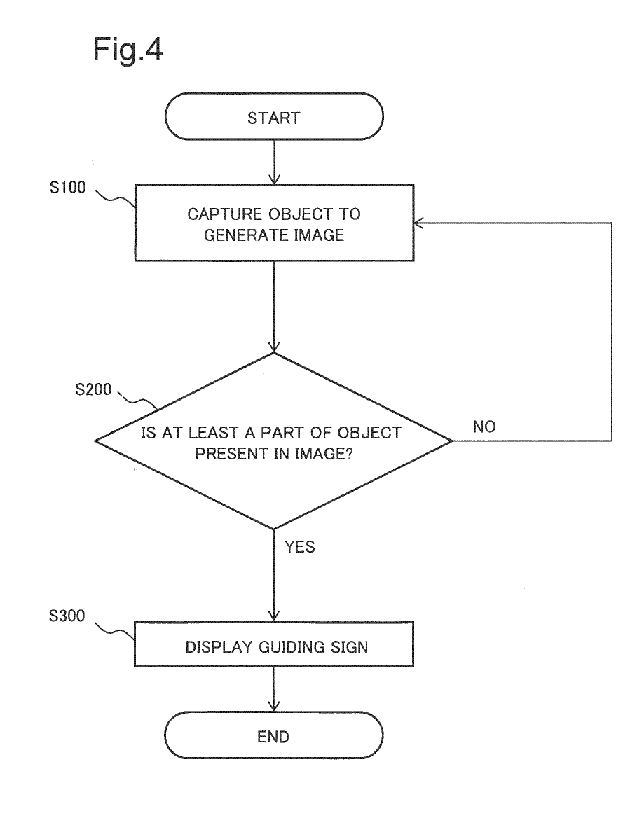

FIG. 4 is a flowchart illustrating actions of the POS terminal apparatus 100 and the information processing apparatus 120. In FIG. 4, steps S100 to S300 are the flowchart illustrating actions of the POS terminal apparatus 100, and steps S200 to S300 are the flowchart illustrating actions of the information processing apparatus 120.

The imaging unit 130 of the POS terminal apparatus 100 captures an image of an object to generate the image (S100). The determining unit 122 in the information processing apparatus 120 determines whether or not at least a part of the object is present in the image (S200). Specifically if the image is a distance image including distance information, it is determined whether or not at least a part of the object is present within ranges of the predetermined vertical direction, horizontal direction, and depth direction which are an imaging area A. If the image is a normal two dimensional image which does not include the distance information, it is determined whether or not at least a part of the object is present within ranges of the predetermined vertical direction and horizontal direction which are the imaging area A.

Next, if at least a part of the object is not present in the image (NO in S200), step S100 starts and the imaging unit 130 captures the image of the object again.

Next if at least a part of the object is present in the image (YES in S200), the control unit 124 displays a guiding sign for guiding the object in the image in the predetermined direction, on the employee display unit 110 (S300). As an example, the control unit 124 performs control the guiding sign which conducts guidance so that the whole object is present in the imaging area A. When the guiding sign which conducts guidance so that the whole object is present therein is displayed, the employee moves the object in accordance with the guiding sign. As a result, since the image of the whole object is captured by the imaging unit 130, image matching with a merchandise image database can be quickly performed.

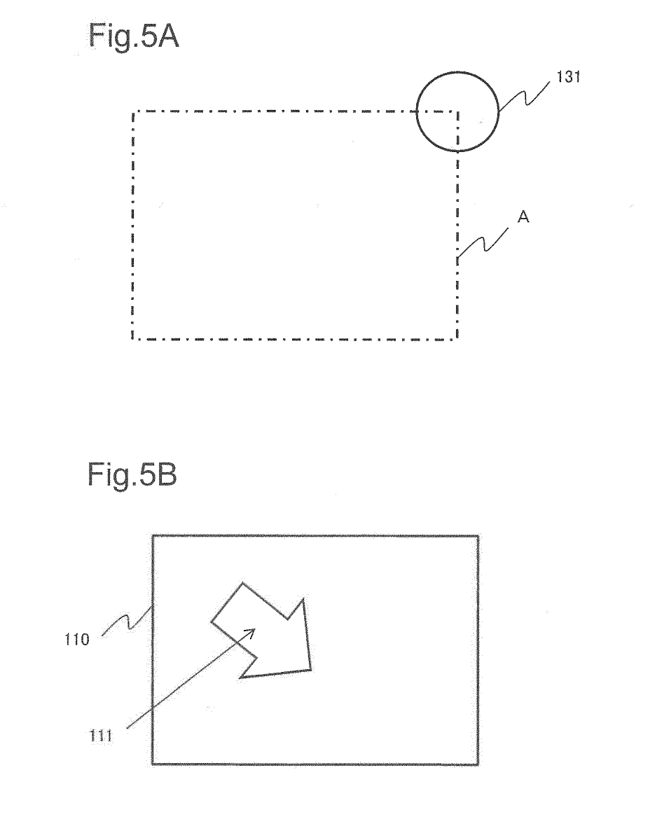

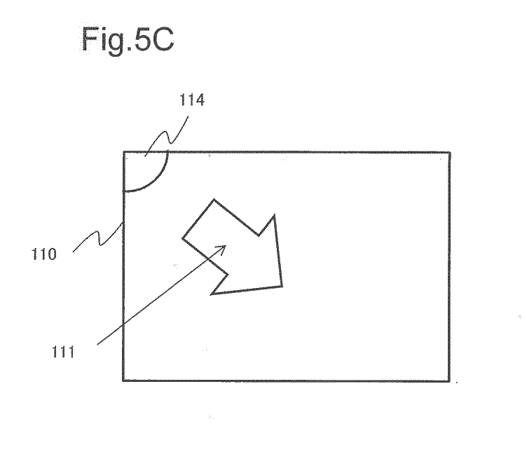

FIG. 5A is a diagram illustrating an example of a positional relationship between an object 131 and the imaging area A in the imaging unit 130 of the POS terminal apparatus in FIG. 2. The imaging area A in FIG. 5A is a region which is set in the direction from the imaging unit 130 to the object. A state where a part of the object 131 is positioned in the imaging area A of the imaging unit 130 is illustrated in FIG. 5A. In FIG. 5A, the object is drawn as a circle, and the object is specifically a fresh food such as a tomato, an apple, etc. or packaged confectionery. The object may have a shape which is not limited to a circle. In FIG. 5A, a part of the object 131 is present at the upper right side in the imaging area A as seen from the imaging unit 130 side.

FIG. 5B is a diagram illustrating an example of a guiding sign 111 displayed on the employee display unit 110 in FIG. 3 or in FIG. 4. When at least a part of the object 131 is present in the image captured by the imaging unit 130 (FIG. 4), the control unit 124 (FIG. 4) recognizes which part of the image a part of the object 131 is present by performing image processing.

The image captured by the imaging unit 130 is composed of pixels divided in the vertical direction and horizontal direction. The control unit 124 recognizes which pixel the object is located on.

Further the control unit 124 determines the guiding direction so that the whole object 131 is present within the imaging area A. The control unit 124 calculates a direction from a position of a pixel at which the image of the object is captured to a position of a pixel which is approximately located at a center of the whole image to determine the guiding direction. In this case, the position of the image of the object captured by imaging unit 130 and the position of the object which an employee sees from a work position are symmetrically located. Considering this point, the control unit 124 displays the guiding sign 111 corresponding to the guiding direction on the employee display unit 110.

As illustrated in FIG. 5C, the control unit 124 may display a captured image of an object 114 with the guiding sign 111 on the display unit 110. When the captured image of the object 114 is displayed on the employee display unit 110, the position of the image of the object captured by the imaging unit 130 and the position of the object which an employee sees from a work position are also symmetrically located. The control unit 124 therefore displays an image inverting the horizontal with respect to the center of the image on the employee display unit 110. Since the employee can confirm the position where the object is present and the guiding sign on the employee display unit 110, the employee can move the object so that the whole image of the object can be captured. Consequently, since the whole image of the object can be captured by the imaging unit 130, image matching with the merchandise image database can be quickly performed.

The control unit 124 may change a color displayed on the employee display unit 110 with movement of the object 131 other than the guiding sign of an arrow illustrated in FIG. 5A to FIG. 5C. For example, when the whole object is present in the imaging area A, green may be displayed, when half or more than half of the object is present therein, yellow may be displayed, and when less than half of the object is present therein, red may be displayed.

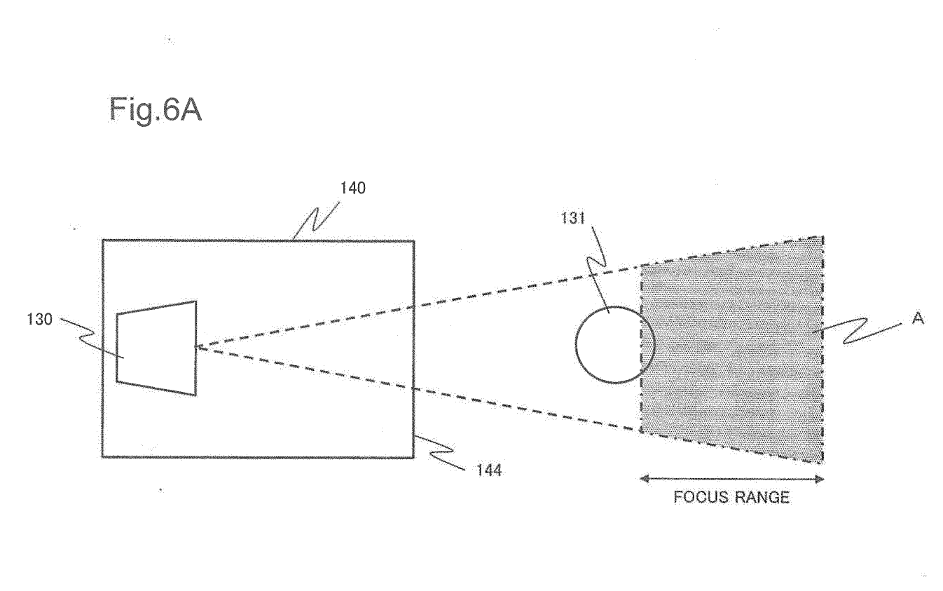

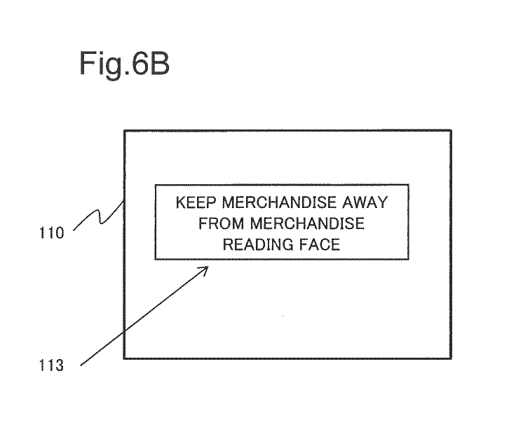

FIG. 6A is a diagram illustrating a positional relationship between an object and the imaging area A, in the first exemplary embodiment. The imaging unit 130 which is placed in the merchandise reading apparatus 140 which is a part of the POS terminal apparatus captures the image of the object 131 through the merchandise reading surface 144. As illustrated in FIG. 6A, a part of the object 131 is present in the imaging area A and is positioned close to the imaging unit 130 rather than the imaging area A.

In this case, the control unit 124 (FIG. 4) determines that the object 131 is located near the imaging unit 130 as compared with the imaging area A based on obtaining the distance to the object by the imaging unit 130 in the first case and second case above mentioned. The control unit 124 recognizes, based on obtained information on the distance, where a part of the object 131 is located in the depth direction of the image. The control unit 124 displays, on the employee display unit 110, the guiding sign for guiding the object in the image in the predetermined direction. As a desirable example, the guiding sign is displayed on the employee display unit 110 so that the whole object is located within the imaging area A.

FIG. 6B is a diagram illustrating a guiding sign displayed in a employee display unit 110. As illustrated in FIG. 6A, in a case of requiring to move the object toward the depth direction with respect to the imaging unit 130, the control unit 124 displays characters “Keep the merchandise away from the merchandise reading surface.” as the guiding sign 113. As another guiding sign, when the object is quite close to the merchandise reading surface 144 (FIG. 6), the control unit 124 displays red, and when the object is quite far from the merchandise reading surface 144, the control unit 124 displays green.

Although the exemplary embodiment has been described with respect to the structure in which the POS terminal apparatus 100 includes the imaging unit 130, the employee display unit 110, the determining unit 122 and the control unit 124, the exemplary embodiment is not limited to the above structure. For example, a structure is available, in which the POS terminal apparatus 100 includes the imaging unit 130 and the employee display unit 110, the information processing apparatus 120 which is placed outside the POS terminal apparatus 100 includes the determining unit 122 and the control unit 124, and the POS terminal apparatus 100 is connected to the information processing apparatus 120 by wire or wireless

### Second Exemplary Embodiment

Next, a second exemplary embodiment is described. The second exemplary embodiment differs from the first exemplary embodiment in that an information processing apparatus 120 includes a memory unit 126 and a matching unit 128. Constituents which are substantially similar to those of the first exemplary embodiment have the same signs as those thereof, and explanations on the constituent are omitted.

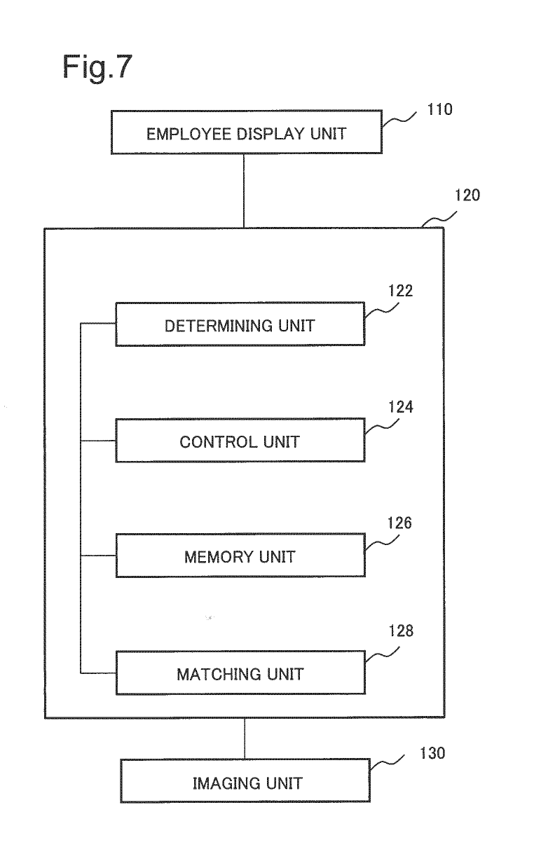

FIG. 7 is a block diagram illustrating a structure of the POS terminal apparatus 100 in the second exemplary embodiment. The POS terminal apparatus 100 in the second exemplary embodiment includes the memory unit 126 and the matching unit 128 in addition to the constituents in FIG. 3. The memory unit 126 stores a merchandise image database. The merchandise image database includes information on a shape and a color which represents characteristics of merchandise images of each the merchandise. The matching unit 128 matches an image captured by the imaging unit 130 with the characteristics of the merchandise image in the merchandise image database and identifies the merchandise corresponding to he captured image.

For example, when programs are run under control of the control unit 124, the determining unit 122 and the matching unit 128 are realized. Specifically, programs stored in the memory unit 126 are run to be realized. In the above explanations, the merchandise image database is stored in the memory unit 126. However it is not limited thereto. A memory apparatus (not illustrated) which is placed outside the POS terminal apparatus 100 may store the merchandise image database. In this case, the matching unit 128 obtains characteristics of merchandise images from the memory apparatus and compares the image captured by the imaging unit 130 with the characteristics.

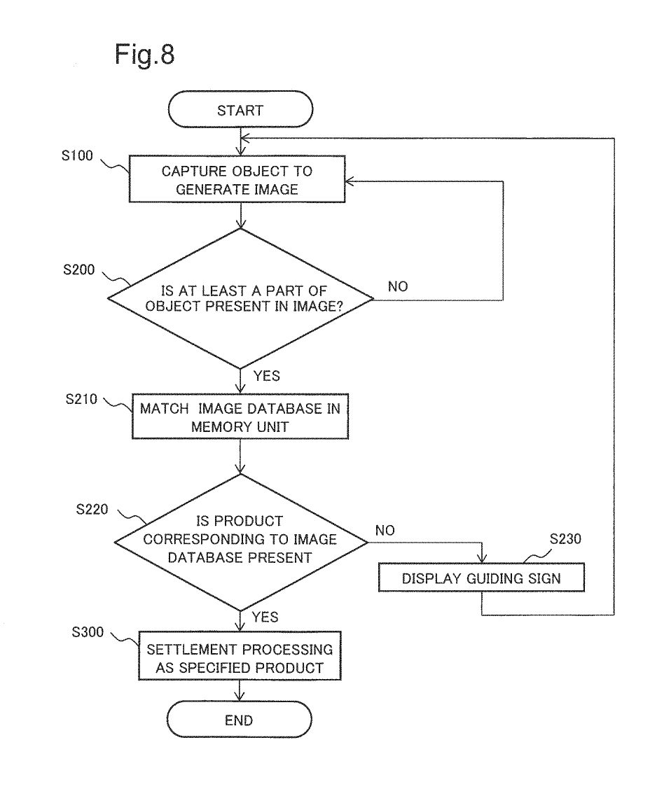

FIG. 8 is a flowchart illustrating operations of the POS terminal apparatus 100 or the information processing apparatus 120. In FIG. 8, in FIG. 4, step S100 to step S300 represent a flowchart illustrating operations of the POS terminal apparatus 100, and step S200 to step S230 which are a part thereof represent a flowchart illustrating operations of the information processing apparatus 120.

The imaging unit 130 in the POS terminal apparatus 100 captures an image of an object to generate an image (S100). Next, the determining unit 122 of the information processing apparatus 120 determines whether or not at least a part of the object is present in the image (S200). Specifically, if the image is a distance image including distance information, it is determined whether or not at least a part of the object is present within ranges of the predetermined vertical direction, horizontal direction, and depth direction which are the imaging area A. If the image is a normal two dimensional image which does not include the distance information, it is determined whether or not at least a part of the object is present within ranges of the predetermined vertical direction and horizontal direction which are the imaging area A.

Next, if at least a part of the object is not present in the image (NO in S200), step S100 starts and the imaging unit 130 captures the image of the object again.

The determining unit 122 may not perform processing of NO in S200. That is because merchandise is possibly specified by image comparing of the next step.

When at least a part of the object is present in the image (YES in S200), the matching unit 128 matches the captured image with the merchandise image database stored in the memory unit 126. If the matching unit 128 identifies the merchandise which corresponds to the captured image as a result of the matching, the control unit 124 proceeds to settlement processing for the specified merchandise (S300). If the matching unit 128 fails to identify the merchandise corresponds to the captured image as a result of the matching, the control unit 124 displays a guiding sign on the employee display unit 110 (S230). The guiding sign is similar to the display illustrated in FIG. 5B or FIG. 6C, and FIG. 6B.

Although the exemplary embodiment is described of a case that the POS terminal apparatus 1 includes the imaging unit 130, the employee display unit 110, the determining unit 122, the matching unit 128 and the control unit 124, the exemplary embodiment is not limited to the above case. For example, a structure is possible, in which the POS terminal apparatus 100 includes the imaging unit 130 and the employee display unit 110, the information processing apparatus 120 which is placed outside the POS terminal apparatus 100 includes the determining unit 122, the control unit 124 and the matching unit 128, and the POS terminal apparatus 100 is connected to the information processing apparatus 120 by wire or wireless.

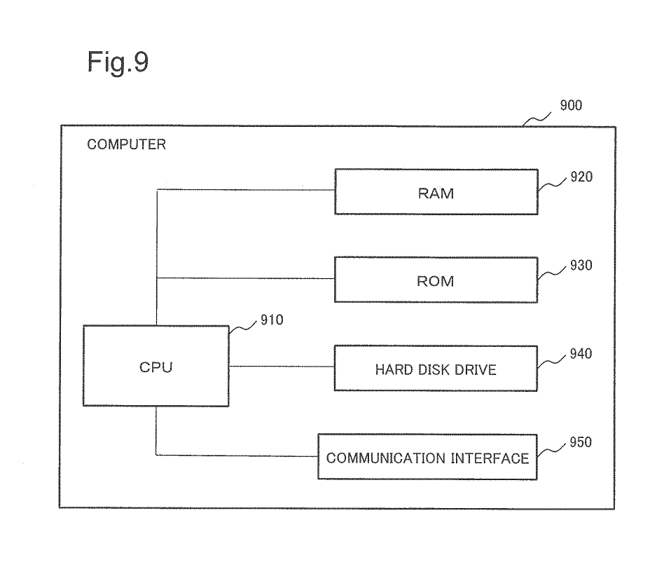

At least a part of the information processing apparatuses 50 and 120 above mentioned may be realized by programs (software program, computer program) executed by a CPU 910 of a computer 900 illustrated in FIG. 9. Specifically programs which are constituents of the determining unit 30 and the control unit 40 of FIG. 1, the determining unit 122 and the control unit 124 of FIG. 3 and FIG. 7, and the matching unit 128 of FIG. 7 are executed to be realized. These constituents may be realized by reading programs from a ROM (Read Only Memory) 930 or a hard disk drive 940 by the CPU (Central Processing Unit) 910, and executing the read programs using the CPU 910 and a RAM (Random Access Memory) 920 in accordance with the flowchart processes in FIG. 4 and FIG. 8. In this case, it can be understood that the invention which is explained in the above exemplary embodiment as an example can be configured by codes representing the computer program or a computer-readable recording medium storing the codes representing the computer program. The computer-readable recording medium is, for example, a hard disk drive 940, a detachable magnetic disk medium, an optical disk medium, or a memory card (not illustrated). The determining unit 30 and the control unit 40 in FIG. 1, the determining unit 122 and the control unit 124 in FIG. 3 and FIG. 7, and the matching unit 128 in FIG. 7 may be exclusive hardware including an integrated circuit.

As described above, the invention is explained using the above exemplary embodiments as a typical example. The invention of the present application is not limited to the above mentioned embodiments. It is to be understood that to the configurations and details of the invention of the present application, various changes can be made within the scope of the invention of the present application.

This application claims priority from Japanese Patent Application No. 2014-065932 filed on Mar. 27, 2014, and the contents of which are incorporation herein by reference in their entirety.

### REFERENCE SIGNS LIST

1 POS terminal apparatus
10 Imaging unit
20 Display unit
30 Determining unit
40 Control unit
50 Information processing apparatus
100 POS terminal apparatus
110 Employee display unit
111 Guiding sign
112 Employee display unit
113 Guiding sign
114 Image of an object
120 Information processing apparatus
122 Determining unit
124 Control unit
128 Matching unit
130 Imaging unit
131 Object
140 Merchandise reading apparatus
142 Housing
144 Merchandise reading surface
900 Computer
910 CPU
920 RAM
930 ROM
940 Hard disk drive
950 Communication interface

1. A POS terminal apparatus, comprising:
an imaging unit that images an object and generates an image thereof;
a display unit that displays a guiding sign for guiding the object in the image to a predetermined direction;
a determining unit that determines whether at least a part of the object is present in the image or not; and
a control unit that performs a control so as to display the guiding sign on the display unit in a cases that at least a part of the object is present in the image.

2. A POS terminal apparatus of claim 1, further comprising:
a matching unit that match the image of the object against a merchandise image database,
wherein the control unit that performs a control to display the guiding sign on the display unit, in a case that no merchandise is found to be matched with the object as a result of the matching.

3. The POS terminal apparatus of claim 1,
wherein the guiding the object in the image to the predetermined direction is to guide the object in such a way that whole of the object included in an imaging area of the imaging unit within which the imaging can be performed.

4. The POS terminal apparatus of claim 1,
wherein the guiding the object in the image in the predetermined direction is a guidance along a depth direction within a focus range of an imaging area of the imaging unit within which the imaging can be performed.

5. The POS terminal apparatus of claim 1,
wherein the guiding the object in the image to the predetermined direction is guidance in a vertical direction, a horizontal direction, or a direction combining the vertical and horizontal directions in an imaging area within which the imaging unit can capture an image.

6. The POS terminal apparatus of claim 1, wherein color of the guiding sign changes depending on a position of the object in the image.

7. An information processing apparatus, comprising:
a determining unit that determines whether at least a part of an object is present in an image captured or not; and
a control unit that performs a control so as to display, on a display apparatus, a guiding sign for guiding the object in the image to a predetermined direction in a case that at least a part of the object is present in the image.

8. An information processing system, comprising:
a POS terminal apparatus, including,
an imaging unit that images an object and generates an image thereof; and
a display unit that displays a guiding sign for guiding the object in the image to the predetermined direction;
and
an information processing apparatus, including:
a determining unit that determines whether at least a part of the object in the image is present or not; and
a control unit that performs a control so as to display the guiding sign in a display apparatus in a case that at least the part of the object in the image is present.

9. An image processing method, comprising:
determining whether at least a part of an object in an image captured is present or not; and
displaying a guiding sign on a display apparatus for guiding the object in the image in the predetermined direction in a case where at least a part of the object is present in the image.

10. A non-transitory computer-readable recording medium storing a program that causes a computer to execute:
determining whether at least a part of an object in an image captured is present or not; and
displaying a guiding sign on a display apparatus for guiding the object in the image to the predetermined direction a case where at least a part of the object is present in the image.
